(19) United States
(12) Patent Application Publication
(10) Pub. No.: US 2012/0155714 A1
(43) Pub. Date: Jun. 21, 2012

(54) VEGETATION INDICES FOR MEASURING MULTILAYER MICROCROP DENSITY AND GROWTH

(75) Inventors: James Douglass, Indialantic, FL (US); Thomas Riding, West Melbourne, FL (US); James Willmann, Sebastian, FL (US)

(73) Assignee: PA LLC, Melbourne, FL (US)

(21) Appl. No.: 13/377,375

(22) PCT Filed: Jun. 11, 2010
(86) PCT No.: PCT/US10/38426

§ 371 Date: Mar. 6, 2012

Related U.S. Application Data
(60) Provisional application No. 61/186,349, filed on Jun. 11, 2009.

(51) Int. Cl. G06K 9/00

(52) U.S. Cl. 382/110

(57) ABSTRACT

Disclosed are methods of and systems for producing vegetation information for an area of interest using at least two comparison index values. The comparison index values can be generated based on specific reflectivity characteristics of vegetation relative to non-vegetation.

### CROSS REFERENCE TO RELATED APPLICATION

This application claims the benefit of U.S. Provisional Application No. 61/186,349, filed Jun. 11, 2009, entitled “VEGETATION INDICES FOR MEASURING MULTILAYER MICROCROP DENSITY AND GROWTH,” which is incorporated herein in its entirety by reference as though fully set forth herein.

### BACKGROUND

Many industries would benefit from technologies to identify vegetated areas and their conditions, such as, for example, the growth rate of the vegetation. Remote sensing methods to quantify such conditions have been investigated over many years. Satellite, air and manually based remote sensing systems can provide useful information for such purposes. In particular, imaging methods have been developed in which an area of vegetation is imaged in multiple spectral bands, and an index is calculated from these spectral images. The index is simply a number for each pixel that provides information of interest on the vegetation such as its density. Changes in such an index value over time provide information on the growth rate of the vegetation.

Many of these indices take advantage of the spectral reflectance properties of chlorophyll in order to discriminate vegetation from non-vegetation. Chlorophyll has a relatively high reflectance in the near infrared and a relatively low reflectance in the visible portions of the spectrum, the visible red spectrum in particular. Most other common materials found in the vicinity of vegetation, such as soil, rocks, and water, have about the same reflectance in the near infrared and visible spectral regions. Therefore an index that calculates the difference in infrared and visible pixel values will result in a relatively large value for chlorophyll and a relatively small one for other materials. This is the basis for many vegetation indices.

Since chlorophyll has a sharply higher optical reflectance in the near infrared compared to its reflectance in the visible red region, the pixel values for vegetation in a digital image in the near infrared are therefore relatively high compared to those in the visible red. For other common materials, the infrared and red pixel values tend to be equal. Therefore, a quotient composed of the difference in near infrared and red pixel values divided by the sum of those pixel values produces an index that is relatively high for plant material (roughly in the range of 0.3-0.8) while for other materials such as clouds, snow, soil, rock and concrete this quotient tends to be relatively low or even negative. By using a quotient, changes in illumination intensity (but not spectrum) are cancelled out; a change in illumination in the IR and in the red region is mathematically cancelled out in a quotient.

However, since the reflectance of vegetation is dominated by the reflectance of the uppermost individual leaves, the utility of vegetation indices is generally limited to measuring the area of vegetation as seen from a downward-looking remote sensing system. This would only provide an approximation for quantifying total vegetation. For a single layer of vegetation, such as, for example, grass, this approximation approach can yield a fairly accurate measure of the total vegetation present. However, for layered vegetation, such as a jungle, forest, or even trees, these methods are much less accurate since solar illumination does not penetrate deeply enough into the multiple layers of vegetation to provide an accurate estimate of total vegetation.

### SUMMARY

Some aspects of the invention described herein include a method of producing vegetation information. The method can include providing map information that defines an area of interest for which the vegetation information is desired; providing an imaging system; taking images across a wavelength spectrum for the area of interest using the imaging system; recording imaging data relating to the images; processing the imaging data, wherein the processing comprises generating at least two comparison index values; and producing the vegetation information using the at least two comparison index values. The map information can include the boundary and/or the topographic information of the area of interest. The imaging system can be, for example, a digital camera system. The digital camera system can include a bit depth of at least 12 bits. The digital camera system can be configured to maintain colorimetric stability over a range of exposure levels from full sunlight to near darkness. The digital camera system can be configured to maintain thermal stability over an ambient temperature range typical for where and/or when the images are taken. The wavelength spectrum can include visible light wavelengths. The wavelength spectrum can include near infrared wavelengths.

One of the comparison index values can be a vegetation index value VI(A−B) defined by the formula VI(A−B)=(reflectance to A−reflectance to B)/(reflectance to A+reflectance to B), wherein A and B are different wavelengths. In some embodiments, the vegetation index value derived can be a normalized difference vegetation index (NDVI). In other embodiments, one of the comparison index values can be a vegetation index value VI(B−C) defined by the formula VI(B−C)=(reflectance to B−reflectance to C)/(reflectance to B+reflectance to C), wherein B and C are different wavelengths. In other embodiments, A can be a wavelength in the visible green light spectrum, B can be a wavelength in the visible red light spectrum, and C can be a wavelength in the visible blue light spectrum.

After processing, a negative value of a comparison index value can be set to zero. A normalized difference vegetation index (NDVI) can be produced, and a vegetation index value VI defined by the formula VI=NDVI*VI(A−B)*VI(B−C) can be generated. In some embodiments, one of the comparison index values can be a vegetation index value VI(D−B) defined by the formula VI(D−B)=(reflectance to D−reflectance to B)/(reflectance to D+reflectance to B), wherein B and D are different wavelengths. In other embodiments, A can be a wavelength in the infrared spectrum, B can be a wavelength in the visible red light spectrum, C can be a wavelength in the visible blue light spectrum, and D can be a wavelength in the visible green light spectrum.

In other embodiments, the MLVI can be defined by the formula MLVI=VI(A−B)*VI(B−C)*VI(D−B), wherein A, B, C, and D are different wavelengths. In other embodiments, the MLVI can be defined by the formula MLVI=VI(A−B)+VI(B−C)+VI(D−B), wherein A, B, C, and D are different wavelengths. In another embodiment, the MLVI can be defined by the formula MLVI=E*VI(A−B)+F*VI(B−C)+G*VI(D−B), wherein A, B, C, and D are different wavelengths, and E, F, and G are coefficients whose values are each independently determined by minimizing the root mean square (rms) error between MLVI and the measured vegetation amount. The rms error can be minimized by linear regression. In other embodiments, the MLVI is defined by the formula MLVI=[(reflectance to A−reflectance to B)+(reflectance to B−reflectance to C) (reflectance to D−reflectance to B)]/[reflectance to A+reflectance to B+reflectance to C+reflectance to D], wherein A, B, C, and D are different wavelengths. Merely by way of example, A can be a wavelength in the infrared spectrum, B can be a wavelength in the visible red light spectrum, C can be a wavelength in the visible blue light spectrum, and D can be a wavelength in the visible green light spectrum.

The vegetation index value can be further correlated to a physical characteristic of vegetation in the area of interest to produce the vegetation information. The vegetation information can comprise aerial density. The steps of taking images across a wavelength spectrum for the area of interest, recording imaging data, processing the imaging data, and producing the vegetation information using the at least two comparison index values can be repeated after a time interval. The vegetation information generated before and after the time interval can be compared.

The digital camera system can include an integrated camera system as shown in FIG. 4. The digital camera system can include a dual camera system as shown in FIG. 5.

Some aspects of the invention can include generating a normalized difference vegetation index (NDVI) defined by formula (1). At least one more vegetation index can be generated. Two, three, or more vegetation indices can be generated. Based on reflectivity characteristics of plants of interest, these vegetation indices can be further processed. At least one of these vegetation indices can be correlated to a physical characteristic of vegetation to generate vegetation information for the area of interest.

Some aspects of the invention can include generating a multi layer vegetation index (MLVI) defined by formula (8), formula (9), formula (10), or formula (11). At least one more vegetation index can be generated. Two, three, or more vegetation indices can be generated. Based on reflectivity characteristics of plants of interest, these vegetation indices can be further processed. At least one of these vegetation indices can be correlated to a physical characteristic of vegetation to generate vegetation information for the area of interest.

Some aspects of the invention can include monitoring the vegetation information generated according to the methods described herein over time.

Some aspects of the invention can include a system for producing vegetation information including: map information that defines an area of interest for which the vegetation information is desired; an imaging system adapted to take images across a wavelength spectrum for the area of interest, record imaging data relating to the images; and the imaging system or a computer system adapted to process the imaging data, wherein the processing can include generating at least two comparison index values, and can produce the vegetation information using the at least two comparison index values. The map information can include a boundary of the area of interest. The map information can include topographic information of the area of interest. The imaging system can include a digital camera system. The digital camera system can have a bit depth of at least 12 bits per pixel. The digital camera system can be configured to maintain colorimetric stability over a range of exposure levels from full sunlight to near darkness. The wavelength spectrum can comprise visible light wavelengths. The wavelength spectrum can include near infrared wavelengths.

In some embodiments, the imaging system or computer system can be further adapted to compare index values using a vegetation index value VI(A−B) defined by the formula VI(A−B)=(reflectance to A−reflectance to B)/(reflectance to A+reflectance to B), wherein A and B are different wavelengths. The vegetation index value derived can be a normalized difference vegetation index (NDVI). One of the comparison index values can be a vegetation index value VI(B−C) defined by the formula VI(B−C)=(reflectance to B−reflectance to C)/(reflectance to B+reflectance to C), wherein B and C are different wavelengths. In some embodiments, A can be a wavelength in the visible green light spectrum, B can be a wavelength in the visible red light spectrum, and C can be a wavelength in the visible blue light spectrum. In some embodiments, the imaging system or computer system can be further adapted to set the index value to zero after processing.

In some embodiments, the imaging system or computer system can be further adapted to produce a normalized difference vegetation index (NDVI), and generate a vegetation index value VI defined by the formula VI=NDVI*VI(A−B)*VI(B−C). In some embodiments, one of the comparison index values can be a vegetation index value VI(D−B) defined by the formula VI(D−B)=(reflectance to D−reflectance to B)/(reflectance to D+reflectance to B), wherein B and D can be different wavelengths. In one embodiment, A can be a wavelength in the infrared spectrum, B can be a wavelength in the visible red light spectrum, C can be a wavelength in the visible blue light spectrum, and D can be a wavelength in the visible green light spectrum.

In some embodiments, the imaging system or computer system can be further adapted to produce a multi layer vegetation index (MLVI). In other embodiments, the MLVI can be defined by the formula MLVI=VI(A−B)*VI(B−C)*VI(D−B), wherein A, B, C, and D are different wavelengths. In other embodiments, the MLVI can be defined by the formula MLVI=VI(A−B)+VI(B−C)+VI(D−B), wherein A, B, C, and D are different wavelengths. In another embodiment, the MLVI can be defined by the formula MLVI=E*VI(A−B)+F*VI(B−C)+G*VI(D−B), wherein A, B, C, and D are different wavelengths, and E, F, and G are coefficients whose values are each independently determined by minimizing the root mean square (rms) error between MLVI and the measured vegetation amount. The rms error can be minimized by linear regression. In another embodiment, the MLVI is defined by the formula MLVI=[(reflectance to A−reflectance to B)+(reflectance to B−reflectance to C)+(reflectance to D−reflectance to B)]/[reflectance to A+reflectance to B+reflectance to C+reflectance to D], wherein A, B, C, and D are different wavelengths. Merely by way of example, A can be a wavelength in the infrared spectrum, B can be a wavelength in the visible red light spectrum, C can be a wavelength in the visible blue light spectrum, and D can be a wavelength in the visible green light spectrum.

In some embodiments, the imaging system or computer system can be further adapted to correlate the vegetation index value to a physical characteristic of vegetation in the area of interest to produce the vegetation information. The vegetation information can comprise aerial density. The imaging system or computer system can be further adapted to repeat (c), (d), (e) and (f) after a time interval. The imaging system or computer system can be further adapted to compare vegetation information generated before and after the time interval.

The digital camera system can include an integrated camera system. In other embodiments, the digital camera system can include a dual camera system.

### BRIEF DESCRIPTION OF THE DRAWINGS

FIG. 1 illustrates a schematic of a system for vegetation detection in accordance with an embodiment of the present invention. The system has an optical system that can detect different reflectivity values of the vegetation and of the background to sunlight. The microcrop can be or include Lemna. The background can be or include water.

FIG. 2 illustrates a relationship between microcrop density and mean normalized difference vegetation index (NDVI).

FIG. 3 illustrates the multi layer vegetation index calculated for each one square meter area of vegetation imaged using an imaging system and its associated software as described above. In this example, the vegetation crop used was layered Lemna. Multiple areas of Lemna were imaged having a range of density or layer thickness. The procedures described herein were used, and the resulting multi layer vegetation index was calculated for each area.

FIG. 4 illustrates a schematic of a system for vegetation detection using an integrated camera configuration in accordance with an embodiment of the present invention. The system comprises a lens, beam splitter, a sensor for visual spectra, and a sensor for IR spectra. The vegetation can comprise Lemna.

FIG. 5 illustrates a schematic of a system for vegetation detection using a dual camera configuration in accordance with an embodiment of the present invention. The system comprises a set of lenses, beam splitters, a sensor for visual spectra, and a sensor for IR spectra. The vegetation may comprise Lemna.

### DETAILED DESCRIPTION

It has been recently realized that certain types of micro-crops that grow on the surface of water have commercial value in the production of protein for many applications, including but not limited to animal and human consumption as well as for fuel production. Microcrops are multi-cellular, free-floating plants that can be as small as several millimeters in dimension. An example is Lemna, a genus of the duckweed family, which is the fastest growing multi-cellular plant known. Such crops have been shown to grow at an optimal rate when they grow in a multi-layered matt several millimeters thick or more, and when the thickness is uniform over the area of growth. Achieving and maintaining optimal growth rates, and therefore economic viability, require continuous or nearly continuous harvesting at the optimal matt thickness, and harvesting at a rate that maintains this thickness value.

Methods embodiments of the present invention comprise remote sensing methods with associated indices that are capable of determining the thickness of micro crop vegetation, even though these methods do not work for other vegetation types. It has been determined that the optical properties of Lemna leaves, known as fronds, allow significant optical transmission of light—in particular near infrared light—making remote sensing of a thick matt of such crops a cost effective method for determining crop density over large areas in order to optimize productivity. Imaging systems for this purpose could be deployed on multiple types of platforms including but not limited to stationary towers, aerostats, aircraft, and satellites.

Examples of vegetation indices that have been previously disclosed include the normalized difference vegetation index (NDVI), the enhanced vegetation index (EVI), and the soil adjusted vegetation index (SAVI). These and other indices attempt to quantify the “greenness” of vegetation by taking advantage of the reflectance characteristics of chlorophyll as described above.

As used herein, “plants” refer to living organisms including trees, herbs, bushes, grasses, vines, ferns, mosses, green algae, fungi, and algae. Plants can grow from soil, or free-float within or on the surface of an aqueous medium, such as water.

As used herein, vegetation refers to plants, or an area which is covered by plants. Non-vegetation refers to non-plants, or an area which is not covered by plants.

As used herein, reflectance and reflectivity both refer to the fraction of incident radiation reflected by a surface.

This disclosure describes the application of vegetation indices to layered micro crops, such as, for example, Lemna. An optimal vegetation index is described, the multi layer vegetation index (MLVI) that makes use of the chlorophyll reflectance characteristics not only including the near infrared spectral regions as the indices above, but also the visible spectrum to provide enhanced performance for layered micro crops. Making use of all this information provides an optimal means of quantifying multi layered vegetation. Quantifying multilayered vegetation, in turn, is extremely useful in timing the harvest of such vegetation at the optimal productivity timepoint.

Merely for the purpose of convenience, in the disclosure, solar radiation is used as the light source to generate images. However, other light sources can be used to generate images. For testing purposes, some artificial light sources can be useful. Merely by way of example, incandescent light sources can be used for testing since their outputs include significant amounts of near infrared radiation. Other types of artificial lighting such as, for example, fluorescent lighting may not be useful since they do not emit significant near infrared radiation.

Satellite, air and manually based remote sensing systems can be useful for identifying vegetated areas and their conditions, such as, for example, plant canopies, density, growth rate, and/or the like. Merely by way of example, a commercial growth of crops or microcrops, such as, for example, Lemna, or microalgae, can benefit from an effective way to measure their aerial density. The aerial density information can comprise, for example, how much vegetation is present per unit area. The vegetation can comprise, but is not limited to, crop or microcrop. Such information, at a single time point or over a time period, can provide a qualitative and/or quantitative evaluation as to, for example, efficiency of area or a bioreactor utilization, and/or growth rate of the crop or microcrop, which can further guide the practice of crop or microcrop growing. For example, growth rate of the crop or microcrop can provide guidance regarding whether the crop or microcrop gets sufficient light, water, fertilizer, and/or the like, or when to harvest.

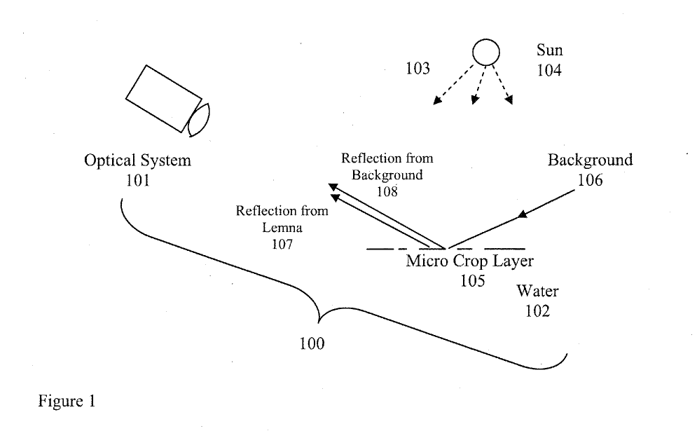

Raw imaging data from a sensing system, such as, for example, from an optical system shown in FIG. 1, can be transformed to an index based on the reflectivity characteristics of a plant to a spectrum of wavelengths. Merely by way of example, NDVI can be such an index. For a pixel on an image or collection of images, NDVI can be defined as the quotient of the difference in reflectivity value to the near infrared and to visible red to the sum of those same values for the same pixel of a image, as follows:

NDVI=(NIR−RED)/(NIR+RED), (1)

where NIR and RED denote the spectral reflectances acquired in the near infrared and red regions, respectively. NIR and RED are defined as ratios of the reflectance over the incoming radiation in each spectral band individually. Accordingly, NIR and RED can vary from 0.0 to 1.0. NDVI can vary from −1.0 to 1.0.

The near infrared region is defined as wavelengths in the near infrared spectrum, which is defined as a range of wavelengths from about 700 nm to about 1400 nm. The red region is defined as wavelengths in the visible red light spectrum, which is defined as a range of wavelengths from about 620 nm to about 700 nm. The visible green light spectrum is defined as a range of wavelengths from about 495 nm to about 570 nm. The visible blue light spectrum is defined as a range of wavelengths from about 450 nm to about 475 nm.

NDVI makes use of the unique spectral reflectivity properties of chlorophyll within a plant compared to other common materials, such as, for example, soil, or water. Chlorophyll is a green pigment found in most plants, algae, and cyanobacteria. Chlorophyll is vital for photosynthesis, which allows plants to obtain energy from light. Merely by way of example, live green plants can absorb solar radiation in the photosynthetically active radiation (PAR) spectral region. These plants can use the absorbed solar radiation as a source of energy in the process of photosynthesis to convert carbon dioxide into organic compounds, for example, sugars. These plants can scatter, by way of example, reflecting and/or transmitting, solar radiation in the near infrared spectral region whose energy per photon is insufficient for photosynthesis. For plants containing chlorophyll, NIR can be higher than RED. Accordingly, NDVI for such plants can be positive.

Merely by way of example, free standing water, such as, for example, oceans, seas, lakes, or rivers, can have rather low values for both NIR and RED, and a very low positive or slightly negative NDVI. Soils can have NIR slightly higher than RED, and a small positive NDVI.

Accordingly, NDVI can be used to qualitatively and/or quantitatively differentiate vegetation from non-vegetation. NDVI can be further processed to generate information about, such as, for example, aerial density. Aerial density can be referred to as leaf area index (LAI), which describes the fraction of the area covered by plants. LAI can be calculated by the ratio of the area represented by the pixels whose NDVI is higher or lower than a threshold value to the total area of interest. If each pixel on an image represents the same area, LAI can be calculated by the ratio of the number of the pixels whose NDVI is higher or lower than a threshold value to the total number of pixels on the image for the area of interest. The area of interest can be defined by map information, which can comprise a boundary and/or topographic information of the area of interest.

The following description is presented in the context of a microcrop, such as, for example, Lemna, growing in water, merely for the purpose of convenience.

FIG. 1 illustrates a schematic of a system 100 for evaluating the growth of a microcrop in an area of interest by an optical system 101. The microcrop can grow on or close to the surface of water 102. Solar radiation 103 from the sun 104 can strike onto both the microcrop layer 105 and the background 106. The background 106 can comprise the water 102 within the area of interest but not covered by the microcrop and the ambient outside the area of interest but within the range detectable by the optical system 101. An optical system 101 can receive the radiation reflected from the microcrop 107 and from the background 108. The reflectances of the microcrop to certain wavelengths of the solar radiation can be different than those of the background 106. The optical system 101, or other processing devices (not shown in the figure) connected to it, can record the raw imaging data, and transform the raw imaging data to generate a comparison index value, such as, for example, NDVI. NDVI can be compared to a threshold value, and can also be further transformed to vegetation information. The threshold value can be chosen based on the reflectivity characteristics of the plants of interest and of the background. The threshold can be determined from experience. As previously mentioned, the index value, such as, for example, NDVI can vary from 0.3 to 0.8 for vegetation. Non vegetation values tend to be smaller than this range or can even be negative. Consequently, a threshold value of 0.3 can provide adequate discrimination between vegetation and non-vegetation. However, should a crop exhibit values outside this range, the threshold can be lowered or raised until adequate discrimination is achieved. The “adequate” level can depend on the application. The software for performing this comparison between the measured value and threshold value can be custom developed. Merely by way of example, the process for performing the comparison between the measured value and threshold value can comprise: determining whether a pixel value is greater or equal to a threshold value such as, for example, 0.3; designating the pixel as corresponding to vegetation if the value is greater or equal to the threshold value; and designating the pixel as not corresponding to vegetation if the value is less than the threshold value. The vegetation information can comprise, for example, aerial density or LAI, plant canopy, growth rate, and/or the like, and/or any combination thereof.

A potential problem for using an optical system as shown in FIG. 1 to generate vegetation information, such as, for example, LAI, can be that it can receive light reflected from the microcrop, and also from the background. The background can comprise both the immediate background surrounding the microcrop layer (not shown in FIG. 1) which can be the water within the area of interest but not covered by the microcrop, and the ambient outside the area of interest but within the range detectable by the optical system. The ambient can comprise the sky, terrestrial objects, such as, for example, the buildings, or the like, and/or any combination thereof. The ambient can exist no matter what the angle of the optical system is relative to the area of interest. For example, an optical system positioned normal to the surface of the area of interest can receive sun radiation reflected by the sky; an optical system positioned non-normal to the surface can receive sun radiation reflected by the terrestrial objects present in the ambient. An accurate differentiation between the solar radiation reflected by the microcrop and reflected by the background can improve the quality of the acquired vegetation information.

Vegetation information, such as, for example, LAI, can be difficult to obtain when there are multiple overlapping layers of a microcrop. The amount of light reaching a layer of the microcrop can vary inversely with the number of layers above it. Similarly, the amount of light reflected by that layer and detected by an optical system can vary inversely with the number of layers above it. These can result in that the difference in a comparison index value for, such as, for example, NDVI, of the vegetation and of non-vegetation can vary inversely with the number of layers above it.

Some embodiments comprise using a camera system with a greater precision. The camera system can comprise a digital camera system which can have a greater “bit depth”. Merely by way of example, a digital camera system which can take an image and transform it to image data of 8 bits per pixel can suffice for an NDVI measurement of about 2 to about 3 overlapping layers of a microcrop; a digital camera system which can take an image and transform it to digital image data of 12-18 bits or more per pixel can suffice for an NDVI measurement of about 3 or more overlapping layers of a microcrop.

Another improvement of the camera system can be on the degree of colorimetric stability and/or thermal stability. The relative values of an image and/or its digital image data for the red, green and blue channels can be maintained over a range of exposure levels and/or over a range of ambient temperature, for example, during a typical day where and when the images for NDVI measurements are taken. An exposure level can vary from full sunlight to near darkness. Ambient temperature can vary from about −50 degrees Celsius to about 100 degrees Celsius, or from about −25 degrees Celsius to about 80 degrees Celsius, or from about −10 degrees Celsius to about 60 degrees Celsius, or from about 0 degree Celsius to about 50 degrees Celsius, or from about 10 degrees Celsius to about 40 degrees Celsius. The colorimetric stability and/or thermal stability of the camera system can be improved by linearity and stability in camera gain and offset, in the detector array(s), in the analog and digital electronic circuitry which can comprise the amplifiers and/or the A/D converters, or the like, or any combination thereof.

Some embodiments comprise using a digital camera system and taking images of an area of interest over a wavelength spectrum. The wavelength spectrum can comprise wavelengths across visible light region. The wavelength spectrum can comprise near infrared region. The imaging data can be processed to generate at least two comparison index values for each pixel of the image(s) for an area of interest. Three, four, or more comparison index values can also be generated. At least two comparison index values can be chosen based on the reflectivity characteristics of the plant of interest, or of an element of the plant of interest. Merely by way of example, for chlorophyll and/or chlorophyll-containing plants of a first type whose reflectance to the green light is higher than to the red light, and reflectance to the red light is higher than to the blue light, the comparison index values can be the following vegetation index values defined by the formulae:

VI(green−red)=(reflectance to green−reflectance to red)/(reflectance to green+reflectance to red), and (2)

VI(red−blue)=(reflectance to red−reflectance to blue)/(reflectance to red+reflectance to blue). (3)

To measure vegetation information for an area of interest where there are chlorophyll-containing plants of the first type, these two indices can be used simultaneously with NDVI to improve the accuracy of differentiating vegetation over non-vegetation than just one NDVI alone, and can improve the following processing of the imaging data. For example, the vegetated area can be identified and LAI can be calculated. At least one of the vegetation index values can be correlated to a physical characteristic of vegetation. Merely by way of example, NDVI can be correlated to the aerial density of the plants NDVI represents. The physical characteristic of vegetation can comprise aerial density, photosynthesis capacity, growth rate, or the like, or any combination thereof.

These vegetation indices can be further transformed. For example, based on the reflectivity characteristics described above for the plants of the first type, both VI(green−red) and VI(red−blue) can be positive. If one of the two vegetation indices has a negative value for a pixel of the image(s), the pixel can represent a non-vegetation area, and the vegetation index value for that pixel can be set to zero. The non-zero product of these two vegetation indices and NDVI can be a mathematical means for determining whether the reflectivity characteristics exist simultaneously.

Merely by way of example, if there are objects of a second type in the same area of interest, and if the objects of the second type have reflectance to the green light higher than to the red light, and the reflectance to the blue light also higher than to the red light, the values of VI(green−red) and VI(red−blue) can be calculated using Equations (2) and (3). The negative vegetation index can be set to zero. The non-zero product of these two indices and NDVI can be a mathematical means for differentiating the plants of the first type and the objects of the second type. Or, the image data can be transformed as follows:

VI(blue−red)=(reflectance to blue−reflectance to red)/(reflectance to red+reflectance to blue). (4)

Equations (2) and (4) can be applied to calculate the vegetation indices VI(green−red) and VI(blue−red) for the area of interest. The negative vegetation index can be set to zero. The non-zero product of these two indices and NDVI can be a mathematical means for determining whether the reflectivity characteristics of the objects of the second type exist simultaneously. This way, a map for distribution of the plants of the first type and the objects of the second type can be created for the area of interest. The objects of the second type can be plants.

Images for an area of interest can be taken over time, at a regular or an irregular interval. The image data for each time point can be processed using any of the methods described above. The vegetation information for different time points can be compared, and can indicate, such as, for example, growth rate of plants, or the relative growth rates of plants of different types. Such information can be guidance as to whether growth conditions for plants are desirable, when to harvest, or the like, or any combination thereof.

The image sensing system can comprise a variety of cameras and sensing systems. The image sensing system can comprise a single integrated near infrared (IR)/visible camera or a combination of two cameras. In embodiments comprising two cameras, one of the cameras is an IR camera and the other is a visible camera.

The imaging system comprises software that can integrate pixel information, compute a series of mathematical calculations, and create an output that defines vegetative crop density information.

An embodiment of the present invention comprises a method for determining the thickness of micro crop vegetation comprising:

1. Positioning a camera system wherein the area of vegetation is in the field of view. This can require the camera to be deployed on a view-enhancing location. The location can be, for example, a tower, a tethered balloon or an aircraft. The deployment method can depend on the area being imaged, the geographic conditions or other factors dependent on the operational environment.

2. Placing reference targets in the field of view. The targets can be of known reflectivity in the visual and IR spectra ranges. These targets can be used to correct for the effects caused by the variation of the solar radiation from day to day and over the course of a day. The targets can be, but are not limited to, Lemna. Merely by way of example, a good reference target is several small areas of Lemna of known but different densities that span the density range of interest.

3. Obtaining matching IR and visual images of the area of interest. Merely by way of example, several image sets can be collected in order to have as much redundant measurement sets as reasonably possible. The image sets can be transferred to a general-purpose computer for further processing. The image sets can be in raw, tiff, bmp, nef or other compatible formats. Compressed image files, such as jpeg files, can not be suitable due to compression artifacts.

4. Remapping image sets so that the same pixel location in each image represents the same point in object space as close as possible. Merely by way of example, the geometric remapping procedure described below can be used for this transformation.

5. Correcting the images for the cosine fourth exposure falloff, from the center to the edges and corners of the resulting image, to correct for the reduction of light intensity near the edges of the image as described further.

6. Measuring the calibration targets in the image and computing an average vegetation index for those known target areas. The average vegetation index can be MLVI. This permits calibration of the multi layer vegetation index value to the absolute weight and density of the Lemna in units such as grams/meter². Also, the variance of that measurement set average is computed to provide a measure of the accuracy of the measurement.

7. Selecting the area of interest, in which the measurement of the Lemna mass is desired. The selection process can be automatic or manual. If the measurement area is known in advance, then the analysis software can automatically select that area of interest. In many cases the operator may want to manually select an area for analysis. The average multi layer vegetation index over that area is computed. Using the calibrated data from the reference targets in step 6 above, the weight of the Lemna mass can be determined.

FIG. 1 illustrates the geometry of the imaging system, solar illumination, and microcrop layers.

Image Sensing Hardware

The image sensing system can consist of a variety of cameras and sensing systems. The system can comprise an integrated near-IR/visible camera or a system of two cameras: one IR camera and one visible camera.

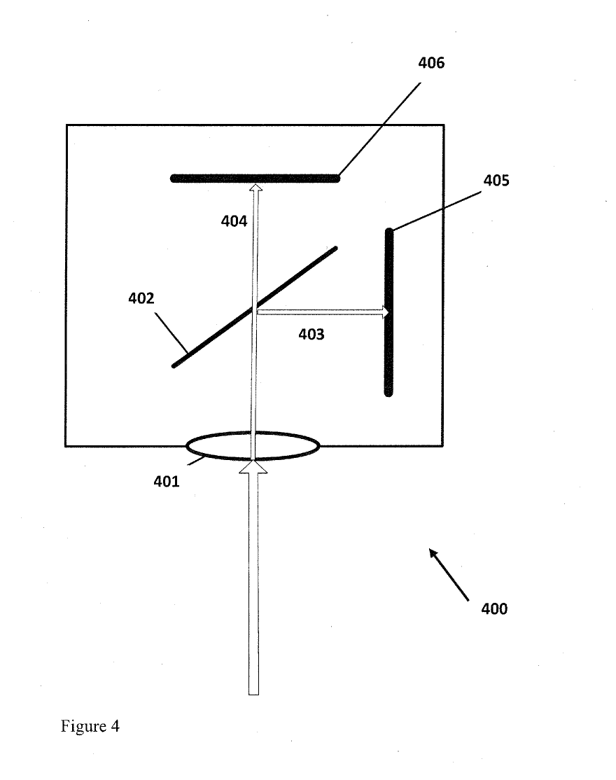

An example of an integrated camera system 400 is shown in FIG. 4. This camera system comprises a single lens 401 and a beam splitter 402 which separates the visible and IR radiation and directs them to two separate imaging arrays. One array 405 is sensitive to the near IR spectrum 403 and the other 406 to the visible spectrum 404. These arrays can be CCD (charge coupled device) or CMOS (complementary metal oxide semiconductor) arrays and can be controlled by a common set of electronics. It is important that the sensor arrays 405 and 406 be precisely aligned so that the same pixel from each array covers the same measured object target. This is not always possible, so a mathematical procedure for geometrically mapping one array to the other is used. An exemplary mathematical procedure is described below.

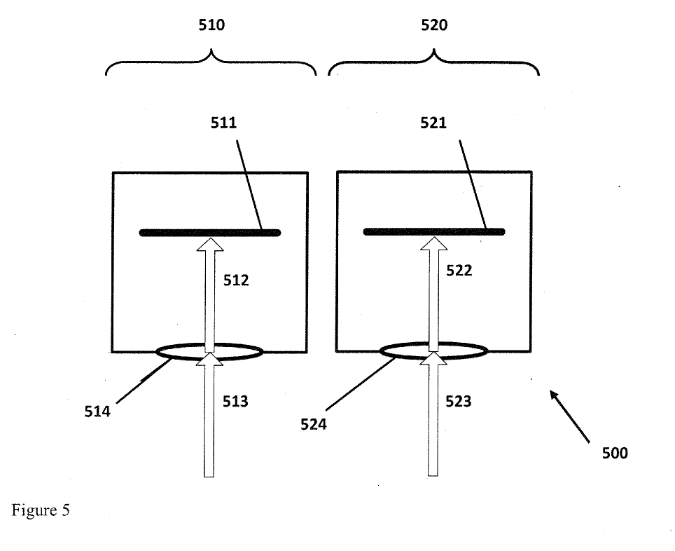

A dual camera system 500 is shown in FIG. 5. In this configuration there is one visible camera 510 and one near-IR camera 520. The visible camera system 510 comprises a single lens 514 through which the visible light spectrum 513 enters and the beam 512 is directed to a RGB visual sensor 511. The near-IR camera system 520 comprises a single lens 524 through which the visible light spectrum 523 enters and the beam 522 is directed to an IR sensor 521. The cameras are mounted solidly in close proximity so that geometrically, the image each camera captures is as close as possible to the image of the other camera. Because of differences in lens characteristics and other factors, a mathematical procedure is employed to transform the pixels from one camera into the image space of the other. This is the same procedure as is used for the integrated camera described above. The inventors have built the dual system using modified commercially available Nikon® camera systems and a custom housing to rigidly hold the cameras in the same position relative to each other.

Software Components

Geometric Calibration and Correction

The remapping of the images from the IR and visible arrays can be performed as follows. First a calibration image can be collected by the system. This calibration image can be selected so that many easily located targets covering the entire image area are visible to both the IR and visible arrays. The coordinates of each of these points in the calibration image can be measured in the pixel space of each array. As a result, a large number of pixel (x,y) coordinates can be obtained for each array. The number of pixel x,y coordinates is preferably 100 points or more. Then using a geometric transformation model which accounts for translation, rotation, scale factor and possibly other effects, the coefficients or parameters of the geometric transformation can be determined, which maps one set of pixel coordinated into the other. After applying this transformation, pixel (x,y) from the visible image covers the same object space as the pixel (x,y) from the IR image. The geometric transformation model is used in geographic mapping, surveying and aerial photography. These methods have been adapted to develop a program to make these transformations.

Radiometric and Colorimetric Calibration and Correction

It is desirable to obtain an image of the micro crops that is properly exposed such that none of the pixels is saturated and none is completely unexposed. A process may involve adjusting the camera system exposure such as, for example, imaging calibration targets in the same scene that contains the micro crops. Such an object can have as high a reflectance value as any area of the micro crop surface. The exposure can be adjusted prior to operational use by imaging these calibration objects, and adjusting exposure. Merely by way of example, adjusting exposure can comprise adjusting the appropriate number and/or shutter speed until the exposure for a calibration target is just under the maximum exposure value the camera system is capable of.

Colorimetric calibration is a procedure that guarantees that colors are imaged with fidelity. Merely by way of example, it is required that an area of equal red, green, and blue pixel values, which is a white area, remains white under varying combinations of illumination and exposures. Calibrating each spectral band with the procedure in the previous paragraph ensures this. White calibration targets are utilized and can be either fabricated with white paint or purchased for this purpose.

Flat Fielding

A fundamental issue in imaging systems is the exposure variation across the detector array commonly called the cosine fourth falloff. In an optical imaging system, for a given object luminance (brightness), the image illuminance at the sensor declines as one moves outward from the center of the image as a result of the geometric optics involved. The result is a relative darkening of the image toward its borders. Considering a lens having certain ideal properties, it can be shown that the decline in relative illuminance varies very nearly as the fourth power of the cosine of the angle by which the object point is off the camera axis. The camera is calibrated for this fall-off by imaging a flat image and determining the fall-off coefficient, which is generally the fourth power of the cosine. Merely as way of example, a least squares fit of the fall-off coefficients to the measured data as a function of the angle from the center of the image can be used.

Multi Layer Vegetation Index (MLVI)

Some indices will provide a measure of total vegetation for some types of layered vegetation. An example of such vegetation is Lemna. Simply constructed indices have been found to be effective for layered Lemna whose thickness is that for optimal growth and harvesting. The NDVI can be effective as such an index.

Most of the indices that have been previously described do not take full advantage of known spectral characteristics of chlorophyll. For instance, the NDVI only uses two spectral bands to take advantage of the relatively high reflectance of chlorophyll in the near infrared compared to the visible red band. However, it is also known that chlorophyll has a relatively high reflectance in the visible green bands, and relatively low in the red and blue bands.

Moreover, reflectance in the visible blue spectral region is relatively low compared with the red region. There is, in other words, more information available to include in an index than is utilized in existing indices. Improved discrimination of vegetation from non-vegetation would result by using this additional information as well as improved sensitivity for quantifying multi layered vegetation.

There are multiple means for including this additional information, hence the multi layer vegetation index is not just a single index, but is a family of indices.

Merely by way of example, the additional information can be added by constructing three basic indices and combining the indices. For instance, if “infrared”, “red”, and “blue” indices can be defined as follows:

Index_infrared=(ir−red)/(ir+red) (5)

Index_green=(green−red)/(green+red) (6)

Index_red=(red−blue)/(red+blue) (7)

These can then be mathematically combined these through multiplication, or addition, to give:

MLVI_{—}1=Index_infrared*Index_green*Index_red, or (8)

MLVI_{—}2=Index_infrared+Index_green+Index_red (9)

Then the resulting indices would include all the spectral information of chlorophyll over these spectral regions. Other combinations are also possible.

Merely by way of example, another means of introducing this additional information can be to form a linear combination of the three indices given above to yield:

MLVI_{—}3=a*Index_infrared+b*Index_green+c*Index_red, (10)

Where a, b, and c are coefficients whose values can be determined by minimizing the rms error between the MLVI_{—}3 and actual (measured) vegetation amounts over a range of densities. The rms error can be computed by linear regression, which can be performed with several programs such as, for example, MatLab, MathCAD, OriginLab, or Maple. Other programs can be used to perform this analysis.

Merely by way of example, another means of including all the known spectral reflectance information of chlorophyll can be to create quotients in which the numerator included a sum of all the spectral differences that are largest for vegetation and smallest for non-vegetation. The denominator could include the sum of those same components for normalization purposes. An example of this approach can yield:

MLVI_{—}4=[(ir−red)+(green−red)+(red−blue)]/[ir+red+green+blue] (11)

The means can comprise other variations on this exemplary approach.

In another embodiment, the MLVI can be defined by the formula MLVI=VI(A−B)*VI(B−C)*VI(D−B), wherein A, B, C, and D are different wavelengths. In another embodiment, the MLVI can be defined by the formula MLVI=VI(A−B)+VI(B−C)+VI(D−B), wherein A, B, C, and D are different wavelengths. In another embodiment, the MLVI can be defined by the formula MLVI=E*VI(A−B)+F*VI(B−C)+G*VI(D−B), wherein A, B, C, and D are different wavelengths, and E, F, and G are coefficients whose values are each independently determined by minimizing the root mean square (rms) error between MLVI and the measured vegetation amount. The rms error can be minimized by linear regression. In another embodiment, the MLVI is defined by the formula MLVI=[(reflectance to A−reflectance to B)+(reflectance to B−reflectance to C)+(reflectance to D−reflectance to B)]/[reflectance to A+reflectance to B+reflectance to C+reflectance to D], wherein A, B, C, and D are different wavelengths. Merely by way of example, A can be a wavelength in the infrared spectrum, B can be a wavelength in the visible red light spectrum, C can be a wavelength in the visible blue light spectrum, and D can be a wavelength in the visible green light spectrum.

The density of Lemna is expressed in units of milligrams of dry weight but since the Lemna density was obtained over a 1 square meter area in this example, it is a measure of the density in units of milligrams per square meter. Since the thickness of these areas at the highest density was well over 5 millimeters, the multi layer vegetation index clearly quantifies the amount of vegetation even though it is present in a thick, multi-layered matt.

This general method as described is not limited to Lemna microcrops. These methods and applications can be applicable to other multi layered crops such as, for example, water hyacinth, wolffia, spirodela, water ferns, and the like.

Embodiments of the present application are further illustrated by the following examples.

### EXAMPLES

The following non-limiting examples are provided to further illustrate embodiments of the present application. It should be appreciated by those of skill in the art that the techniques disclosed in the examples that follow represent approaches discovered by the inventors to function well in the practice of the application, and thus can be considered to constitute examples of modes for its practice. However, those of skill in the art should, in light of the present disclosure, appreciate that many changes can be made in the specific embodiments that are disclosed and still obtain a like or similar result without departing from the spirit and scope of the application.

### Example 1

### Method of Imaging Growing Lemna

A digital camera system was used to image growing Lemna. The camera system recorded images taken across the visible spectrum and in the near infrared spectrum. A total of 4 spatially-registered images were produced as shown below:

TABLE 1

| | | Approximate |
|---|---|---|
| | | Wavelength |
| | Image Type | Region (nm) |
| Image 1 | Blue | 450 |
| Image 2 | Green | 550 |
| Image 3 | Red | 650 |
| Image 4 | Nir | 700-1000 |

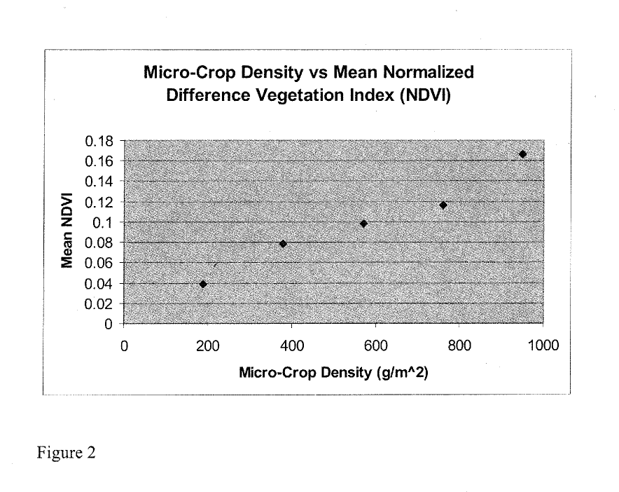

The NDVI was calculated using Equation (1). The NDVI was averaged over all pixels covering the Lemna growth. The density of Lemna was measured manually. These data are shown in FIG. 2. In the density range of approximately 1000 g/m̂2, the Lemna were growing in about 4 layers deep. Hence, this data shows the efficacy of the NDVI for measuring multilayer micro crops such as Lemna.

### Example 2

### Method of Imaging Growing Lemna

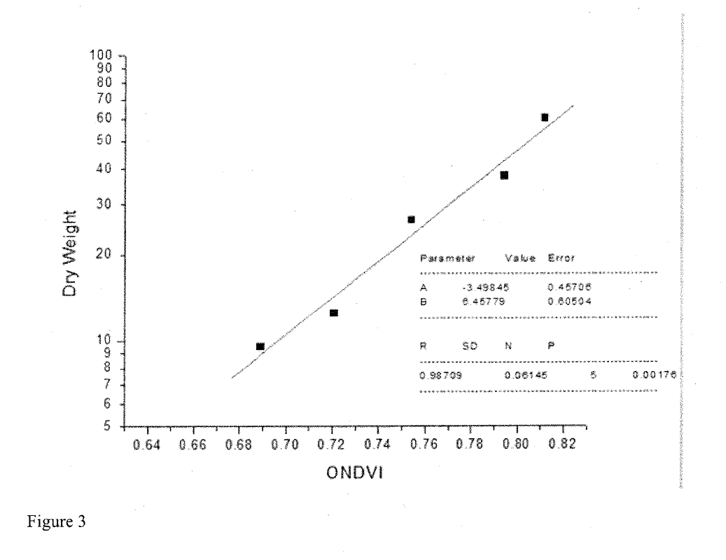

An imaging system and its associated software as described above was used to image multiple one square meter areas of a microcrop. In this example, layered Lemna was used as the crop. Multiple areas of Lemna were imaged having a range of density, or layer thickness. The procedures previously described were used, and the resulting multi layer vegetation index was calculated for each area. A plot of the results is shown in FIG. 3.

A person of ordinary skill in the relevant art will recognize the applicability of various configurations and features from different embodiments described herein. Similarly, the various configurations and features discussed above, as well as other known equivalents for each configuration or feature, can be mixed and matched by one of ordinary skill in this art to perform methods in accordance with principles described herein. It is to be understood that examples described are for illustration purposes only, and are not limiting as to the scope of the invention.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the numbers expressing quantities of ingredients, properties such as molecular weight, reaction conditions, and so forth, used to describe and claim certain embodiments of the application are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A method of producing vegetation information comprising:
(a) providing map information that defines an area of interest for which the vegetation information is desired;
(b) providing an imaging system;
(c) taking images across a wavelength spectrum for the area of interest using the imaging system;
(d) recording imaging data relating to the images;
(e) processing the imaging data, wherein the processing comprises generating at least two comparison index values; and
(f) producing the vegetation information using the at least two comparison index values.

2. (canceled)

3. The method of claim 1, wherein the map information comprises topographic information of the area of interest.

4. The method of claim 1, wherein the imaging system comprises a digital camera system.

5. (canceled)

6. The method of claim 4, wherein the digital camera system is configured to maintain colorimetric stability over a range of exposure levels from full sunlight to near darkness.

7. The method of claim 1, wherein the wavelength spectrum comprises visible light wavelengths.

8. The method of claim 1, wherein the wavelength spectrum comprises near infrared wavelengths.

9. The method of claim 1, wherein one of the comparison index values is a vegetation index value VI(A−B) defined by the formula VI(A−B)=(reflectance to A−reflectance to B)/(reflectance to A+reflectance to B), wherein A and B are different wavelengths.

10. The method of claim 9, wherein the vegetation index value derived is a normalized difference vegetation index (NDVI).

11.-17. (canceled)

18. The method of claim 1, wherein one of the comparison index values is a multi layer vegetation index (MLVI).

19. The method of claim 18, wherein the MLVI is defined by the formula MLVI=VI(A−B)*VI(B−C)*VI(D−B), wherein A, B, C, and D are different wavelengths.

20. The method of claim 18, wherein the MLVI is defined by the formula MLVI=VI(A−B)+VI(B−C)+VI(D−B), wherein A, B, C, and D are different wavelengths.

21. The method of claim 18, wherein the MLVI is defined by the formula MLVI=E*VI(A−B)+F*VI(B−C)+G*VI(D−B), wherein A, B, C, and D are different wavelengths, and E, F, and G are coefficients whose values are each independently determined by minimizing the root mean square (rms) error between MLVI and the measured vegetation amount.

22. (canceled)

23. The method of claim 18, wherein the MLVI is defined by the formula MLVI=[(reflectance to A−reflectance to B)+(reflectance to B−reflectance to C)+(reflectance to D−reflectance to B)]/[reflectance to A+reflectance to B+reflectance to C+reflectance to D], wherein A, B, C, and D are different wavelengths.

24. The method of claim 9, further comprising correlating the vegetation index value to a physical characteristic of vegetation in the area of interest to produce the vegetation information.

25. The method of claim 1, wherein the vegetation information comprises aerial density.

26. The method of claim 1, further comprising repeating (c), (d), (e) and (f) after a time interval.

27. The method of claim 26, further comprising comparing vegetation information generated before and after the time interval.

28.-46. (canceled)

47. The system of claim 1, wherein one of the comparison index values is a multi layer vegetation index (MLVI).

48.-58. (canceled)
